(19) United States
(12) Patent Application Publication
(10) Pub. No.: US 2003/0158917 A1
(43) Pub. Date: Aug. 21, 2003

(54) Modifying system configuration based on parameters received from an infrastructure

(76) Inventors: Felix G.T.I. Andrew, Seattle, WA (US); Randal J. Ramig, Seattle, WA (US); Zeke Koch, Seattle, WA (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/067,580

(22) Filed: Feb. 4, 2002

(51) Int. Cl. G06F 15/16

(52) U.S. Cl. 709/220; 709/227

(57) ABSTRACT

A computer system is connected to an infrastructure from among a number of infrastructures. For example, a mobile computer system may be connected to a corporate intranet or a home network. The computer system receives one or more parameters that are provided by the infrastructure. The received parameters may include a network address and a subnet mask. The received parameters are combined to generate an identifier that is representative of an environment the computer system will operate in. Generating an identifier may include combining a network address and a subnet mask to determine a network location. Based on the identifier, characteristics associated with the environment the computer system will operate in are selected. The selected characteristics may facilitate changing the configuration of the computer system to operate in the environment represented by the identifier.

### BACKGROUND OF THE INVENTION

1. The Field of the Invention

The present invention relates to changing the configuration of a system based on parameters associated with an infrastructure. More specifically, the present invention relates to systems, methods, and computer program for selecting characteristics of a computer system based on one or more parameters received from an infrastructure.

2. Background and Relevant Art

Computer systems are often moved between different physical locations. This is especially true of mobile computer systems, such as mobile telephones and personal digital assistants (“PDAs”). Moving computer systems between different physical locations may result in the computer systems being connected to different infrastructures. For example, a PDA may be connected to corporate intranet when at the office, a mobile carrier service provider when outside the office, and an Internet Service Provider (“ISP”) when at home. Different infrastructures may be associated with different operating environments and a computer system may need to be configured differently for proper operation in each of the different operating environments. For example, a corporate intranet infrastructure may be associated with a proxy server, while a wireless carrier service provider infrastructure may be associated with a virtual private network (“VPN”). When a computer system is communicating via the corporate intranet infrastructure it may require different parameters than when communication via the mobile carrier service provider infrastructure.

Each time an infrastructure is changed, a computer system may need to be reconfigured to operate in the environment provided by the infrastructure. This is problematic, as a user must often perform manual operations to reconfigure a computer system. For example, a user may need to reenter parameters associated with communication techniques when a computer system is moved from a corporate intranet infrastructure to an ISP infrastructure. If a user lacks the technical expertise or incorrectly enters configuration information, the computer system may not be able to operate in a particular environment. This problem is compounded in mobile computer systems that have limited input capabilities and/or that change infrastructures frequently.

Therefore, what are desired are systems, methods, and computer program products for configuring the behavior of a computer system based on parameters received from an infrastructure.

### BRIEF SUMMARY OF THE INVENTION

Methods, systems, and computer program products are described for modifying the configuration of a computer system based on parameters received from an infrastructure. A computer system may be connected to a network that is associated with one or more network parameters. Based on the computing environment associated with these parameters, the computer system may modify its configuration. In some embodiments, a computer system may utilize addressing parameters to determine a network location. Based on the network location, communication techniques used by the computer system may be modified.

A computer system is connected to an infrastructure from among a number of infrastructures. This may include a computer system connecting to a network from among a number of networks, such as a corporate intranet or the Internet. For example, a mobile computer system may be connected to the Internet via a mobile carrier service provider and then connect to a corporate intranet using a VPN. Alternately, a mobile computer system may be connected to a specific docking station chosen from among a number of docking stations. That is, a mobile computer system is connected to an office docking station at the office and a home docking station at home.

The computer system receives one or more parameters that are associated with the computer system and that were provided by the infrastructure. This may include a computer system receiving one or more parameters from a network. The one or more parameters may include communication parameters used by the network. Received parameters may include network addressing parameters, for example, an Internet Protocol (“IP”) address and/or a subnet mask. When a computer system is connected to a docking station, the computer system may receive one or more parameters associated with components included in a docking station.

The one or more parameters are combined to generate an identifier. The identifier may be representative of an environment the computer system will connect to. The identifier may be representative of whether a computer system is connected to a corporate intranet or connected to the Internet. For example, the identifier may be generated by performing a logical “AND” operation on an IP address and a subnet mask to generate a subnet address. Such an identifier may be representative of a network location where a computer system will operate.

Based on the identifier, one or more characteristics associated with the environment the computer system is connected to are selected. This may include selecting communication techniques the computer system will utilize, such as whether resources are to be accessed via a proxy or by establishing a Virtual Private Network (“VPN”) connection. For example, if the identifier is representative of a corporate intranet location, characteristics may be selected to enable a computer system to utilize a proxy that is included in the corporate intranet. However, if the identifier is representative of an Internet location, characteristics may be selected to enable a computer system to utilize a VPN connection to the corporate intranet. In a docking station environment, characteristics may be selected to enable a computer system to operate with one or more peripheral devices associated with the docking station.

Identifiers may be stored and reused. This may include storing identifiers in a database for retrieval at a later time. When an identifier is generated, a database key that associates the identifier with a particular environment may be opened. A value may be assigned to the database key that is indicative of a particular environment. This may include indicating whether an identifier represents a corporate intranet or the Internet. For example, a first value may be associated with a corporate intranet and a second value may be associated with the Internet. Thus, when an identifier is generated, the database can be searched to determine the network location represented by the identifier. A system registry is an example of a database that may be used to store identifiers.

The present invention has the advantage of reducing the technical expertise that is needed to properly configure a computer system when it is switched between infrastructures. The present invention also has the advantage of reducing the amount of configuration information that is manually entered when a computer system is switched between infrastructures. These factors increase the chance that a computer system will be properly configured when the computer system is switched between infrastructures.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a telephonic device that provides a suitable operating environment for the present invention.

FIG. 2 illustrates example of some of the functional components that may facilitate modifying a computer system's configuration based on an identifier.

FIG. 3 illustrates an example of a network environment that provides a suitable operating environment for the present invention.

FIG. 4 is a flow diagram illustrating an example of a method for selecting characteristics of a computer system based on parameters associated with an infrastructure.

### DETAILED DESCRIPTION OF THE PREFERRED EMBODIMENTS

The present invention extends to systems, methods, and computer program products for selecting characteristics of a computer system based on parameters received from an infrastructure. A computer system is connectable to a number of infrastructures, such as corporate intranets, docking stations, home networks, airports, networks in different countries, and the Internet. Each infrastructure may provide one or more parameters that are representative of an operating environment associated with the infrastructure. The computer system may include modules that facilitate the generation of an identifier that represents an operating environment and that facilitate the selection of computer system characteristics.

In operation, a computer system is connected to an infrastructure from among the number of infrastructures and the computer system receives one or more parameters from the infrastructure. The one or more parameters are combined to generate an identifier that is representative of an environment associated with the infrastructure. The computer system uses the identifier to select computer system characteristics associated with the environment. The selected characteristics may facilitate configuring the computer system in a manner that promotes proper operation in the environment or results in an improved user experience.

The embodiments of the present invention may comprise a general-purpose or special-purpose computer system including various computer hardware components, which are discussed in greater detail below. Embodiments within the scope of the present invention also include computer-readable media for carrying or having computer-executable instructions or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions or data structures and which may be accessed by a general-purpose or special-purpose computer system.

When information is transferred or provided over a network or another communications connection (either hardwired, wireless, or a combination of hardwired or wireless) to a computer system or computer device, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions.

In this description and in the following claims, a “computer system” is defined as one or more software modules, one or more hardware modules, or combinations thereof, that work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data.

Those skilled in the art will appreciate that the invention may be practiced in network computing environments with many types of computer system configurations, including personal computers, laptop computer, hand-held devices, multi-processor systems, microprocessor-based or programmable consumer electronics, network PCs, minicomputers, mainframe computers, mobile telephones, PDAs, pagers, and the like. The invention may also be practiced in distributed computing environments where local and remote computer systems, which are linked (either by hardwired links, wireless links, or by a combination of hardwired or wireless links) through a communication network, both perform tasks. In a distributed computing environment, program modules may be located in both local and remote memory storage devices.

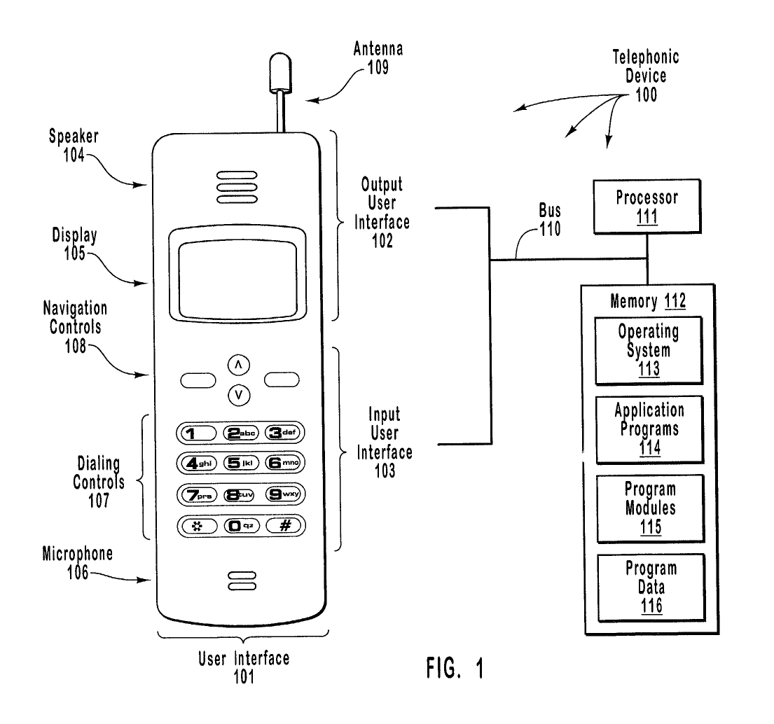

FIG. 1 and the following discussion are intended to provide a brief, general description of a suitable computing environment in which the invention may be implemented. Although not required, the invention will be described in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing steps of the methods disclosed herein. The particular sequences of such executable instructions or associated data structures represent examples of corresponding acts for implementing the functions described in such steps.

With reference to FIG. 1, a suitable operating environment for the principles of the invention includes a general-purpose computer system in the form of a telephonic device 100. The telephonic device 100 includes a user interface 101 for allowing a user to input information through an input user interface 103, and to review information presented via an output user interface 102. For example, the output user interface 102 includes a speaker 104 for presenting audio information to the user, as well as a display 105 for presenting visual information to the user. The telephonic device 100 may also have an antenna 109 if the telephonic device 100 has wireless capabilities.

The input user interface 103 may include a microphone 106 for translating audio information into electronic form. In addition, the input user interface 103 includes dialing controls 107 represented by 112 buttons through which a user may enter information. Input user interface 103 also includes navigation control buttons 108 that assist the user in navigating through various entries and options listed on display 105.

Although user interface 101 has the appearance of a mobile telephone, the unseen features of user interface 101 may allow for complex and flexible general-purpose processing capabilities. For example, telephonic device 100 also includes a processor 111 and a memory 112 that are connected to each other and to the user interface 101 via a bus 110. Memory 112 generally represents a wide variety of volatile and/or non-volatile memories and may include types of memory previously discussed. However, the particular type of memory used in telephonic device 100 is not important to the present invention. Telephonic device 100 may also include mass storage devices (not shown) similar to those associated with other general-purpose computer systems.

Program code means comprising one or more program modules may be stored in memory 112 or other storage devices as previously mentioned. The one or more program modules may include an operating system 113, one or more application programs 114, other program modules 115, and program data 116.

While FIG. 1 represents a suitable operating environment for the present invention, the principles of the present invention may be employed in any system that is capable, with suitable modification if necessary, of implementing the principles of the present invention. The environment illustrated in FIG. 1 is illustrative only and by no means represents even a small portion of the wide variety of environments in which the principles of the present invention may be implemented.

In accordance with the present invention, program modules such as identifier generation modules and characteristics selection modules that facilitate modifying the behavior of a computer system, as well as associated program data, such as parameters received form an infrastructure, may be stored and accessed from any of the computer-readable media associated with telephonic device 100. For example, portions of such modules and portions of associated program data may be included in operating system 113, application programs 114, program modules 115 and/or program data 116, for storage in memory 112. Portions of such modules and associated program data may also be stored in any of the mass storage devices previously described.

Execution of such modules may be performed in a distributed environment as previously described. For example, an identifier generation module included in a local computer system may generate an identifier that is used by a characteristic selection module included in a remote computer system. Likewise, an identifier generation module included in a remote computer system may generate an identifier that is used by a characteristic selection module included in a local computer system.

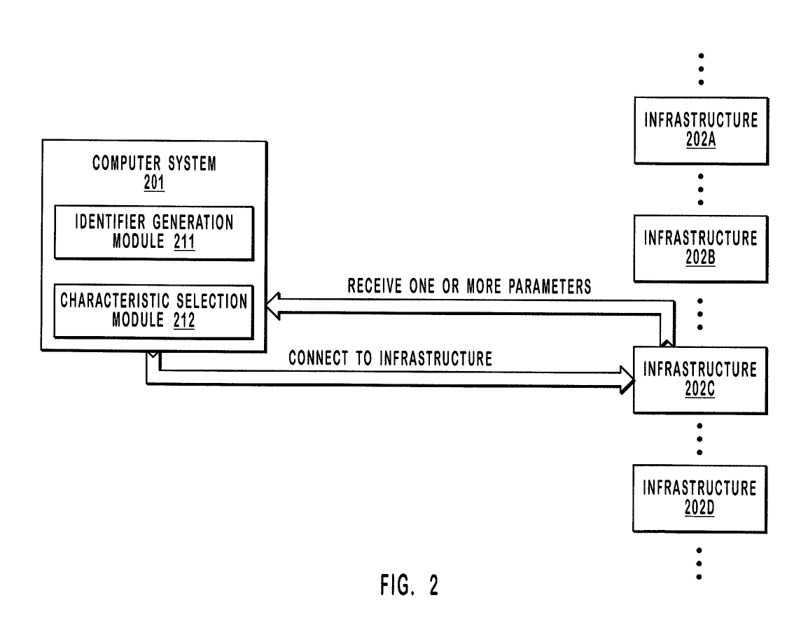

Shown in FIG. 2 are some of the functional components that may facilitate modifying a computer system's behavior based on an identifier that represents the infrastructure or environment that the computer system is connected to. Illustrated in FIG. 2 is computer system 201, which includes identifier generation module 211 and characteristic selection module 212. Also, illustrated in FIG. 2 are infrastructures 202A, 202B, 202C, and 202D. The three periods between each infrastructure represents that the number of infrastructure is flexible. Infrastructures may be capable of providing one or more parameters to computer systems that connect to the infrastructures. For example, when a computer system is connected to an infrastructure, the infrastructure may provide a network address to the computer system as a matter of course.

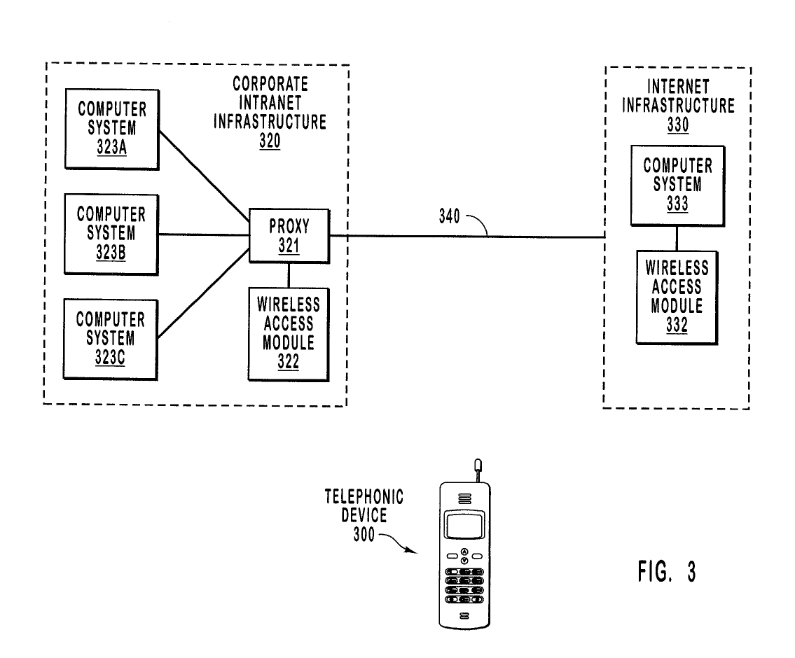

FIG. 3 illustrates an example of a network environment that provides a suitable operating environment for the present invention. Illustrated in FIG. 3 is telephonic device 300, which may be similar to telephonic device 100. Also illustrated in FIG. 3 are corporate intranet infrastructure 320 and Internet infrastructure 330. Telephonic device 300 may use wireless communication techniques to attempt to establish communication with corporate intranet infrastructure 320 via wireless access module 322. Likewise, telephonic device 300 may use wireless communication techniques to attempt to establish communication with Internet infrastructure 330 via wireless access modules 332.

If communication techniques are successfully established via wireless access module 322, telephonic device 300 may communicate with the computer systems included in corporate intranet infrastructure 320. Likewise, if communication techniques are successfully established via wireless access module 332, telephonic device 300 may communicate with the computer systems included in Internet infrastructure 330. Telephonic device 300 may connect to other infrastructures (not shown) in addition to corporate intranet infrastructure 320 and Internet infrastructure 300.

Communication link 340 represents that corporate intranet infrastructure 320 and Internet infrastructure 330 may be logically connected. That is, corporate intranet infrastructure 320 and Internet infrastructure 330 may be connected in a manner that electronic data may be transported between corporate intranet infrastructure 320 and Internet infrastructure 330. The actual physical representation of a communication link 340 is not important and may change over time. Communication link 340 may include hardwired links, wireless links, or a combination of hardwired links and wireless links. Communication link 340 may also include software or hardware modules (not shown) that condition or format portions of data and/or portions of a Virtual Private Network (“VPN”).

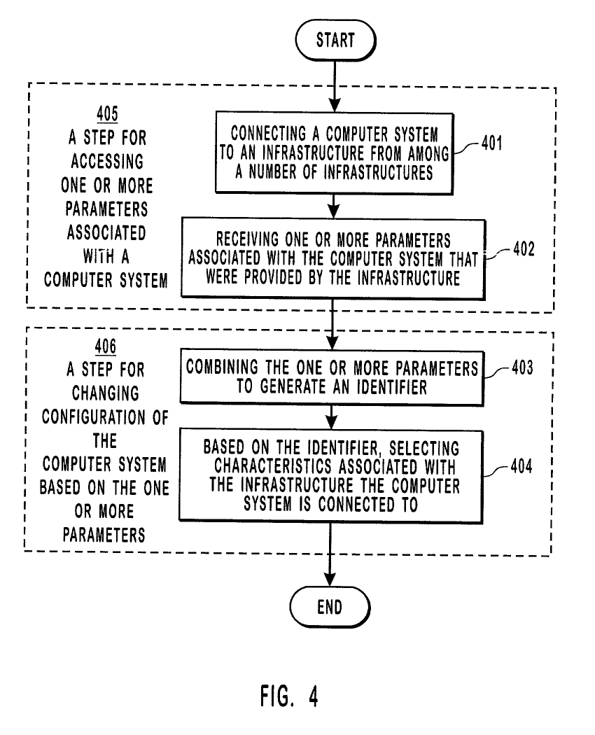

FIG. 4 is a flow diagram illustrating an example of a method for selecting computer system characteristics based on an identifier. The method in FIG. 4 will be discussed with reference to the functional components included in FIGS. 2 and 3.

The method in FIG. 4 may begin with a step for accessing one or more parameters associated with a computer system (step 405). This may include connecting a computer system to an infrastructure from among a number of infrastructures (act 401). Connecting to an infrastructure may include establishing a network connection to an infrastructure. Illustrated by the arrow labeled “Connect To Infrastructure” in FIG. 2, computer system 201 connects to infrastructure 202C, which is one of a number of infrastructures it may connect to. Connecting to an infrastructure may include telephonic device 300 utilizing wireless communication techniques to connect to one of the infrastructures included in FIG. 3. For example, telephonic device 300 may communicate wirelessly with wireless access module 332 so as to connect to Internet infrastructure 330. Telephonic device 300 may connect to Internet infrastructure 330, even though other infrastructures, including corporate intranet infrastructure 320, are available.

Alternatively, connecting to an infrastructure from among a number of infrastructures may include connecting a mobile computer system, such as a PDA or laptop, to a docking station from among a number of docking stations. For example, a corporate docking station infrastructure may exist at an office and a home docking station infrastructure may exist at home. When the laptop is physically located at the office, it may be connected to the corporate docking station infrastructure. Likewise, when the laptop is physically located at home, it may be connected to the home docking station infrastructure.

In some embodiments, connecting to an infrastructure may not include establishing a network connection. In these embodiments, different infrastructures may exist as portions of a network. A mobile computer system may maintain a previously established network connection, even though the mobile computer system is connected to different infrastructures as the mobile computer system moves between physical locations. For example, a laptop with an established connection to a corporate intranet may be moved between different physical locations causing the mobile computer system be connected from different access points. An infrastructure may be associated with a Global Positioning System (“GPS”) network.

Step 405 may include receiving one or more parameters associated with a computer system that were provided by the infrastructure (act 402). Illustrated by the arrow labeled “Receive One Or More Parameters” in FIG. 2, computer system 201 receives one or more parameters that were provided by infrastructure 201C.

This may include a computer system receiving a network address that was provided by a computer network infrastructure. In the networked environment of FIG. 3, this may include telephonic device 300 receiving a network address that was provided by corporate intranet infrastructure 320 or Internet infrastructure 330. A network address is likely to be provided by a network infrastructure that employs the Dynamic Host Configuration Protocol or other similar protocols that automatically assign network addresses. In some cases, a computer system may receive a four-byte Internet Protocol (“IP”) address, for example, “149.212.116.125”. However, the type of address that is provided by an infrastructure or that is received by a computer system is not important. It would be apparent to one skilled in the art, after having reviewed this description, that a variety of address types may be provided by an infrastructure and received by a computer system.

Another parameter that a computer system may receive is a “subnet mask”. A subnet mask may be used to determine what subnet an IP address belongs to. IP addresses may include two portions, a network address portion and a host address portion. For example, the four-byte IP address “149.212.116.125”, may include a two-byte network address portion, represented by “149.212”, and a two-byte host address portion, represented by “116.125”.

Subnets are used to further divide a network by reserving a portion of the host address. Consider an example network that has been assigned the two byte network address portion “149.212”, which may be represented by the binary values “10010101.11010100”. When using four-byte IP addresses, this may leave the remaining two bytes, or 16 bits, to be utilized for host address portions. This represents that 2¹⁶, or 65,536, host machines may be assigned to the network. Thus, it may be desirable to subdivide the network into smaller subnets.

For example, it may be desirable to subdivide the network 149.212 into eight subnets that each may include 2¹³, or 8,192 host machines. As such, the first three bits of the host address portion on the network 149.212 may be utilized to represent a subnet. Consider the four-byte IP address “149.212.116.125”, which may be represented by the binary values “10010101.11010100.01110100.01111101”. In an environment where eight subnets are utilized to subdivide network 149.212, the network address portion of this address would include the first three bits of the host address. Such a network address portion may be represented by the binary values “10010101.11010100.011”. In this same environment the host address portion may be represented by the binary values “10100.01111101”.

A subnet mask represented by the binary values “10010101.11010100.11100000.00000000” may be used to determine which of the eight subnets an IP address is included in. This determination may be made by performing a logical “AND” operation on the subnet mask and IP address. For example, if it was to be determined what subnet of the network 149.212 the four-byte IP address “149.212.116.125” is included in, the following logical AND operation may be performed.

| | |
|---|---|
| Subnet Mask | 10010101.11010100.11100000.00000000 |
| IP Address | 10010101.11010100.01110100.01111101 |
| Result of AND operation | 10010101.11010100.01100000.00000000 |

Thus, it is determined that the IP address 149.212.116.125 is included in the subnet “149.212.96.0”. This is because the binary representation of “01100000”, the byte that includes the first three bits of the host address portion, has a decimal representation of 96. Thus, by using both an IP address and a subnet mask the network location of a computer system may be determined. Although described as four-byte addresses, IP address may include more than four bytes, for example, when an IP address is in accordance with Internet Protocol next generation (“IPng”) or Internet Protocol version 6 (“IPv6”).

In addition to addressing parameters, a computer system may receive other parameters from an infrastructure. Such parameters may include latency of the network, bandwidth available on the network, protocols used by the network, one or more name server addresses, Domain Name suffixes, type of connection, such as dial-up, Ethernet, etc., or any parameters that may facilitate causing a computer system to become aware of an environment associated with the network.

Such parameters may be indicative of a type of communication technique that will enable proper operating with an infrastructure. A computer system may receive one or more parameters that indicate an infrastructure includes a proxy or that communication with an infrastructure may need to be in accordance with a virtual private network (“VPN”). For example, telephonic device 300 may receive one or more parameters from corporate infrastructure 320 that indicate corporate infrastructure 320 communicates with Internet infrastructure 330 via proxy 321.

A proxy is a computer system that may be used to control access to other computer systems. A proxy may forward data from a first computer system to a second computer in a manner such that the second computer system is not able to return communication directly to the first computer system. For example, if computer system 323A desires to communicate with computer system 333, computer system 323A may send packets to proxy 321 that are then forwarded by proxy 321 to computer systems 333, When computer system 333 desires to return communication, computer system 333 may send packets to proxy 321 that are then forwarded by proxy 321 to computer system 323A. Thus, proxy 321 serves as an intermediary that may prevent direct harmful communication from Internet Infrastructure 330 that may be directed at computer system 323A.

When a computer system is connected to a docking station, the computer system may receive one or more parameters provided by the docking station. A computer system may receive parameters associated with software and/or hardware modules that are included in or attached to the docking station. For example, a computer system may receive parameters associated with a monitor, keyboard, or printer that is attached to the docking station. Likewise, a computer system may receive parameters associated with expansion cards, mass storage devices, or memory that is included in the docking station. If a docking station is associated with a basic input/output system (“BIOS”), a computer system may receive parameters associated with the BIOS. For example, if BIOS is associated with a particular stocking keeping unit (“SKU”), a computer system may receive parameters that are indicative of the SKU.

It should be understood that the described types of parameters a computer system may receive are only examples. Implementations of embodiments of the present invention do not depend on the types of parameters that are received. It would be apparent to one skilled in the art, after having reviewed this description, that a wide variety of parameters may be provided by an infrastructure and received by a computer system.

As illustrated and described in FIGS. 2 and 3, computer system 201 and telephonic device 300 are connected to external infrastructures. However, in some embodiments a computer system may be connected to an infrastructure that is internal to the computer system. In such cases, the computer system may also be termed as an infrastructure and the computer system may be “connected to itself.” This may occur, for example, when a computer system is not connected to an external infrastructure.

In these embodiments, a computer system's internal modules may provide and receive one or more parameters associated with the computer system. One or more internal provider modules may provide one or more parameters that are received by one or more internal receiver modules. With reference to FIG. 1, modules included in operating system 113 may provide one or more parameters that are received by modules included in application programs 114. For example, a driver module included in operating system 113 may provide time and date parameters to a communication module included applications programs 114.

It should be understood that this is only an example of internal provider modules providing parameters that are received by internal receiver modules. It would be apparent to one skilled in the art, after having reviewed this description, that a wide variety of internal provider modules may exist in a computer system and may provide a variety of different parameters. Likewise, It would be apparent to one skilled in the art, after having reviewed this description, that a wide variety of internal receiver modules may exist in a computer system and may receive a variety of different parameters. It should also be understood that an internal module may be both a provider module and a receiver module. That is, an internal module may provide as well as receive parameters.

In some embodiments, parameters may be received that were provided by more than one infrastructure. When parameters are received from more than one infrastructure, this may be viewed as receiving parameters from a “combined infrastructure.” A combined infrastructure may include one or more external infrastructures, one or more internal infrastructure, or a combination of external and internal infrastructures. In some combined infrastructures, a plurality of infrastructures external to a computer system may provide one or more parameters. For example, a Dynamic Host Control Protocol (“DHCP”) infrastructure may provide a network address and a GPS infrastructure may provide land navigation coordinates. In other combined infrastructures, internal and external infrastructures may provide one or more parameters. For example, when a laptop is coupled to a docking station, an internal clock infrastructure may provide time parameters and a docking station infrastructure may provide hardware configuration parameters.

Received parameters may be parameters that are associated with the infrastructure that provided the parameters. In FIG. 2, the arrow labeled “Receive One Or More Parameters”, may illustrate that infrastructure 202C is providing one or more parameters to computer system 201 that are associated with infrastructure 202C. For example, in FIG. 3, corporate intranet infrastructure 320 may provide one or more parameters to telephonic device 300 that are associated with corporate intranet infrastructure 320.

Alternately, received parameters may be associated with an infrastructure other than the infrastructure that provided the one or more parameters. That is, a computer system may receive one or more parameters provided by a first infrastructure, where the one or more parameters are associated with a second infrastructure. In these embodiments, the arrow labeled “Receive One Or More Parameters”, may illustrate that infrastructure 202C is providing one or more parameters to computer system 201 that are associated with other infrastructures. For example, in FIG. 3, corporate intranet infrastructure 320 may provide one or more parameters to telephonic device 300 that are associated with Internet infrastructure 330.

The method in FIG. 4 may include a step for changing configuration of the computer system based on the one or more parameters (step 406). This may include combining one or more parameters to generate an identifier (act 403). A computer system may combine received parameters by performing mathematical, logical, or text based operations on the parameters. In FIG. 2, identifier generation module 211 may receive one or more parameters that were provided by infrastructure 202C and perform operations on the one or more parameters to generate an identifier. One type of logical operation previously discussed, is performing a logical “AND” operation on a subnet mask and an IP address to generate a subnet address. A generated subnet address may be an identifier.

A single parameter may be combined with itself by truncating portions of the parameter, performing mathematical, logical, or text based operations on the parameter in combination with other static information, or otherwise using only the single parameter to generate an identifier. It should be understood that described methods for generating an identifier are merely examples. It would be apparent to one skilled in art, after having reviewed this description, that one or more receive parameters may be combined in a variety of ways to generate an identifier.

In some embodiments, changing the configuration of a computer system may be based on one or more parameters that are not combined. An infrastructure may be aware that computer systems change configuration based on received parameters. Such infrastructures may combine representative information into one or more parameters before providing them to a computer system. Thus, when the one or more parameters are received at a computer system, the parameters may be in a format that is usable by the computer system without further combination.

Step 406 may also include automatically selecting characteristics associated with the environment the computer system is connected to, based on the identifier (act 404). In FIG. 2, characteristic selection module 212 may receive an identifier from identifier generation module 211. In response to receiving the identifier, characteristic selection module 212 may select characteristics of computer system 201 that are associated with the environment represented by the identifier. If an identifier is representative of an environment included in infrastructure 202C, characteristic selection module 212 may select characteristics that cause computer system 201 to operate with infrastructure 202C.

A single infrastructure may include a plurality of different environments. For example, a single network may include multiple subnets and each subnet may be associated with one or more different parameters. In FIG. 3, computer system 323A, computer system 323B and computer system 323C may each be included in different subnets of corporate intranet infrastructure 320. A characteristics selection module included in telephonic device 300 may select different characteristics to communicate with each of the computer systems 323A, 323B, and 323C. It may be that some characteristics are different for each environment while others remain the same. For example, although, telephonic device 300 may select different characteristics to communicate with computer systems in different subnets of corporate infrastructure 320, telephonic device 300 may select characteristics to utilize proxy 321 for all subnets.

When characteristics associated with an environment are selected, the configuration of a computer system may change. For example in a network infrastructure, selected characteristics associated with communication devices may cause a change in configuration. Telephonic device 300 may use a wireless network interface card (“NIC”) when communicating with corporate intranet infrastructure 320, and a wireless modem when communicating with Internet infrastructure 330. When telephonic device 300 switches from communicating with corporate intranet infrastructure 320 to communicating with Internet infrastructure 330, selected characteristics may cause operation of the wireless NIC to cease and operation of the wireless modem to begin.

When a mobile computer system is switched between docking station infrastructures, selected characteristics associated with peripheral devices may cause a change in configuration. A first docking station infrastructure may be associated with a first group of peripheral devices and a second docking station infrastructure may be associated with a second group of peripheral devices. When switching from the first docking station infrastructure to the second docking station infrastructure, selected characteristics may cause drivers associated with the first group of peripherals to be unloaded and drivers associated with the second group of peripherals to be loaded.

In addition to switching between hardware configurations, a computer system's software modules may be configured for an improved user experience. For example, a users “favorites list” may be automatically changed when a computer system is moved between a corporate intranet and a home office network. In a mobile environment, a mobile computer system with an established connection to a wireless corporate LAN may be moved between physical locations, such as different buildings. The mobile computer system may connect to the wireless corporate LAN from different access points as it moves between physically locations. Each wireless access point may be uniquely identified by the mobile computer system. As the mobile computer system detects an access point it may provide relevant maps, such as the map of a building, to the user of the mobile computer system. If a mobile computer system connects to an infrastructure associated with a GPS network, the mobile computer system may detect that has crossed an international border or is otherwise operating in a different country. In such cases, the mobile computer system may automatically change the default language, currency symbols, or other country dependent software settings.

Selected characteristics may be retrieved from a database of stored characteristics. When an identifier is generated, a characteristic selection module may identify selected characteristics from the database. When an identifier is generated, a database key, which may be used to select characteristics from the database, is opened based on the identifier. The database key may be used to select characteristics associated with an environment a computer system is connected to.

If a database key does not exist for a particular environment, a user may be asked to provide information to identify the environment. This may include a user entering one time clarification and/or configuration information to assist in identifying the environment. For example, the first time telephonic device 300 connects to Internet infrastructure 330, as user may need to identify that a generated identifier is associated with Internet infrastructure 330. However, once an environment has been identified, characteristics may there after be selected from the database.

Multiple identifiers may be associated with a single database key and thus the same selectable characteristics. This may occur if different environments operate in a similar manner. For example, even if computer system 323A, computer system 323B, and computer system 323C are included in different subnets the same characteristics may be selected to enable telephonic device 300 to communicate with them. A database may include a system registry, which contains characteristics that may be selected to configure a computer system for operation in different environments. In such embodiments, a database key may be a registry key.

Using identifiers significantly reduces the configuration information that must be manually entered when a computer system switches environments. This reduces the technical expertise needed to properly configure a computer system for operating in different environments, as well as, the amount of configuration information that is manually entered during configuration. Both of these factors increase the chances that a computer system will be properly configured when switching between environments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by United States Letters Patent is:

1. In a computer system that is connectable to a number of infrastructures, each infrastructure being associated with one or more parameters, a method for selecting characteristics associated with the environment the computer system is connected to, so as to reduce the configuration information that is manually entered, comprising the following:
an act of connecting the computer system to an infrastructure from among the number of infrastructures;
an act of receiving one or more parameters associated with the computer system that were provided by the infrastructure;
an act of combining the one or more parameters to generate an identifier; and
an act of, based on the identifier, selecting characteristics associated with the infrastructure the computer system is connected to.

2. The method as recited in claim 1, wherein the act of connecting the computer system to an infrastructure from among the number of infrastructures comprises the following:
act of connecting a mobile computer system to an infrastructure from among the number of infrastructures.

3. The method as recited in claim 1, wherein the act of connecting the computer system to an infrastructure from among the number of infrastructures comprises the following:
an act of connecting the computer system to a network infrastructure from among a number of network infrastructures.

4. The method as recited in claim 3, wherein the act of connecting the computer system to a network infrastructure from among a number of network infrastructures comprises the following:
an act of connecting the computer system to a network infrastructure from among a number of network infrastructures that are each associated with different operating environments.

5. The method as recited in claim 1, wherein the act of connecting the computer system to an infrastructure from among the number of infrastructures comprises the following:
an act of connecting the computer system to a docking station infrastructure from among a number of docking station infrastructures.

6. The method as recited in claim 5, wherein the act of connecting the computer system to a docking station infrastructure from among a number of docking station infrastructures comprises the following:
act of connecting the computer system to a docking station infrastructure from among a number of docking station infrastructures that are each associated with different operating environments.

7. The method as recited in claim 1, wherein the act of connecting the computer system to an infrastructure from among the number of infrastructures comprises the following:
connecting the computer system to a combined infrastructure.

8. The method as recited in claim 1, wherein the act of receiving one or more parameters associated with the computer system that were provided by the infrastructure comprises the following:
an act of receiving one or more parameters associated with the computer system that were provided by a network infrastructure.

9. The method as recited in claim 8, wherein act of receiving one or more parameters associated with the computer system that were provided by a network infrastructure comprises the following:
an act of receiving one or more parameters associated with communication techniques utilized by the network infrastructure.

10. The method as recited in claim 9, wherein the act of receiving one or more parameters associated with communication techniques utilized by the network infrastructure comprises the following:
an act of receiving a network address that was provided by the network infrastructure.

11. The method as recited in claim 9, wherein the act of receiving one or more parameters associated with communication techniques utilized by the network infrastructure comprises the following:
an act of receiving a subnet mask that was provided by the network infrastructure.

12. The method as recited in claim 9, wherein the act of receiving one or more parameters associated with communication techniques utilized by the network infrastructure comprises the following:
an act of receiving one or more parameters indicative of the network infrastructure utilizing a proxy.

13. The method as recited in claim 9, wherein the network infrastructure utilizes a virtual private network.

14. The method as recited in claim 9, wherein the act of receiving one or more parameters associated with the computer system that were provided by the infrastructure comprises the following:
an act of receiving one or more parameters associated with the computer system that were provided by a docking station infrastructure.

15. The method as recited in claim 14, wherein the act of receiving one or more parameters associated with the computer system that were provided by a docking station infrastructure comprises the following:
an act of receiving one or more parameters associated with peripherals that are attached to the docking station infrastructure.

16. The method as recited in claim 1, wherein the act of receiving one or more parameters associated with the computer system that were provided by the infrastructure comprises the following:
an act of receiving one or more parameters associated with the computer system that were provided by a first infrastructure and will be used to select characteristics associated with a second infrastructure.

17. The method as recited in claim 1, wherein the act of receiving one or more parameters associated with the computer system that were provided by the infrastructure comprises the following:
an act of receiving one or more parameters associated with the computer system that were provided by the computer system.

18. The method as recited in claim 1, wherein the act of receiving one or more parameters associated with the computer system that were provided by the infrastructure comprises the following:
an act of receiving one or more parameters from a combined infrastructure.

19. The method recited in claim 1, wherein the act of combining the one or more parameters to generate an identifier comprises the following:
an act of combining the one or more parameters that where provided by a network infrastructure to generate an identifier.

20. The method recited in claim 19, wherein the act of combining the one or more parameters that where provided by a network infrastructure to generate an identifier comprises the following:
an act of combining one or more parameters associated with communication techniques that are utilized by the infrastructure.

21. The method recited in claim 20, wherein the act of combining the one or more parameters associated with communication techniques that are utilized by the infrastructure comprises the following:
an act of performing a logical AND operation on a network address and a subnet mask to generate a subnet address that is representative of a network location.

22. The method recited in claim 1, wherein the act of, based on the identifier, selecting characteristics associated with the infrastructure the computer system is connected to comprises the following:
an act of selecting characteristics associated with the infrastructure the computer system is connected to that cause the computer system to utilize a proxy.

23. The method recited in claim 1, wherein the act of, based on the identifier, selecting characteristics associated with the infrastructure the computer system is connected to comprises the following:
an act of selecting characteristics associated with the infrastructure the computer system is connected to that cause the computer system to utilize a virtual private network.

24. The method recited in claim 1, wherein the act of, based on the identifier, selecting characteristics associated with the infrastructure the computer system is connected to comprises the following:
an act of selecting characteristics associated with a network location the computer system connected to.

25. The method recited in claim 1, wherein the act of, based on the identifier, selecting characteristics associated with the infrastructure the computer system is connected to comprises the following:
an act of selecting characteristics associated with a docking station the computer system connected to.

26. The method recited in claim 1, wherein the act of, based on the identifier, selecting characteristics associated with the infrastructure the computer system is connected to comprises the following:
an act of selecting characteristics associated with the infrastructure from a system registry.

27. The method recited in claim 1, wherein the act of, based on the identifier, selecting characteristics associated with the infrastructure the computer system is connected to comprises the following:
an act of selecting characteristics associated with the infrastructure by utilizing information that was manually entered by a user.

28. The method recited in claim 1, wherein the act of, based on the identifier, selecting characteristics associated with the infrastructure the computer system is connected to comprises the following:
an act of, based on the identifier, selecting characteristics associated with a combined infrastructure the computer system is connected to.

29. The method as recited in claim 1, further comprising:
an act of utilizing the selected characteristics to modify the configuration of the computer system.

30. The method as recited in claim 29, wherein the act of utilizing the selected characteristics to modify the configuration of the computer system comprises the following:
an act of utilizing the selected characteristics to modify the configuration of the computer system to operate in the environment.

31. The method as recited in claim 30, wherein the act of utilizing the selected characteristics to modify the configuration of the computer system to operate in the environment comprises the following:
an act of utilizing the selected characteristics to modify the configuration of the computer system to operate on a computer network.

32. In a computer system that is connectable to a number of infrastructures, each infrastructure being associated with one or more parameters, a method for selecting characteristics associated with the environment the computer system is connected to, so as to reduce the configuration information that is manually entered, comprising the following:
a step for accessing one or more parameters associated with a computer system so as to provide parameters for properly configuring the computer system to operate in an infrastructure;
an act of combining the one or more parameters to generate an identifier; and
an act of, based on the identifier, selecting characteristics associated with the infrastructure the computer system is connected to.

33. The method as recited in claim 32, wherein the step for accessing one or more parameters associated with a computer system comprises the following:
an act of accessing one or more parameters from a computer network.

34. The method as recited in claim 32, wherein the step for accessing one or more parameters associated with a computer system comprises the following:
an act of accessing one or more parameters from a docking station.

35. The method as recited in claim 32, wherein the step for accessing one or more parameters associated with a computer system comprises the following:
an act of accessing one or more parameters from a system registry.

36. The method as recited in claim 32, wherein the step for accessing one or more parameters associated with a computer system comprises the following:
an act of accessing one or more parameters provided modules included in the computer system that may be utilized by the computer system to change the configuration of the computer system.

37. In a computer system that is connectable to a number of infrastructures, each infrastructure being associated with one or more parameters, a method for selecting characteristics associated with the environment the computer system is connected to, so as to reduce the configuration information that is manually entered, comprising the following comprising:
an act of connecting the computer system to an infrastructure from among the number of infrastructures;
an act of receiving one or more parameters associated with the computer system that were provided by the infrastructure; and
a step for changing the configuration of the computer system based on the one or more parameters so as to enable to computer system to operate in the infrastructure associated with the provided parameters.

38. The method as recited in claim 37, wherein the step for changing the configuration of the computer system based on the one or more parameters comprises the following:
an act of configuring the computer system to operate with a computer network.

39. The method as recited in claim 37, wherein the step for changing the configuration of the computer system based on the one or more parameters comprises the following:
an act of configuring the computer system to operate with a docking station.

40. The method as recited in claim 37, wherein the step for changing the configuration of the computer system based on the one or more parameters comprises the following:
an act of configuring the computer system to operate with the computer system.

41. The method as recited in claim 37, wherein the step for changing the configuration of the computer system based on the one or more parameters comprises the following:
an act of configuring the computer system based on one parameter.

42. A computer program product for use in a computer system that is connectable to a number of infrastructures, each infrastructure being associated with one or more parameters, the computer program product for implementing a method for selecting characteristics associated with the environment the computer system is connected to, so as to reduce the configuration information that is manually entered, the computer program product comprising:
one or more computer-readable media carrying computer-executable instructions, that when executed at the computer system, cause the computer system to perform the method, including:
connecting the computer system to an infrastructure from among the number of infrastructures;
receiving one or more parameters associated with the computer system that were provided by the infrastructure;
combining the one or more parameters to generate an identifier; and
selecting characteristics associated with the infrastructure the computer system is connected to.

43. The computer program product as recited claim 42, wherein the one or more computer-readable media are physical storage media.

44. The computer program product as recited claim 42, wherein the one or more computer-readable media include system memory.
